(19) United States
(12) Patent Application Publication
(10) Pub. No.: US 2010/0179301 A1
(43) Pub. Date: Jul. 15, 2010

(54) PROCESS FOR SYNTHESIZING OLIGO/POLYTHIOPHENES BY A "ONE-POT" SYNTHESIS ROUTE

(75) Inventors: Björn Henninger, Koln (DE); Frank Rauscher, Koln (DE); Leslaw Mleczko, Dormagen (DE)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: BAYER TECHNOLOGY SERVICES GMBH, LEVERKUSEN (DE)

(21) Appl. No.: 12/602,660

(22) PCT Filed: Jun. 26, 2008
(86) PCT No.: PCT/EP08/05182

§ 371 Date: Dec. 2, 2009

(30) Foreign Application Priority Data
Jul. 9, 2007 (DE) 10 2007 031 992.6
Jul. 16, 2007 (DE) 10 2007 033 343.0

(51) Int. Cl. C08G 75/00

(52) U.S. Cl. 528/380

(57) ABSTRACT

The present invention is based on a “one-pot synthesis process” for preparing thiophenes from thiophene monomers with two leaving groups under metal catalysis.

The present invention relates to a process for preparing oligo/polythiophenes.

In the last 15 years, the field of molecular electronics has developed rapidly with the discovery of organic conductive and semiconductive compounds. In this time, a multitude of compounds which have semiconductive or electrooptical properties has been found. It is the general understanding that molecular electronics will not displace conventional semiconductor units based on silicon. Instead, it is assumed that molecular electronic components will open up new fields of use in which suitability for coating large areas, structural flexibility, processability at low temperatures and low costs are required. Semiconductive organic compounds are currently being developed for fields of application such as organic field-effect transistors (OFETs), organic luminescent diodes (OLEDs), sensors and photovoltaic elements. Simple structuring and integration of OFETs into integrated organic semiconductor circuits makes possible inexpensive solutions for smart cards or price tags, which have not been realizable to date with the aid of silicon technology owing to the cost and the lack of flexibility of the silicon units. It would likewise be possible to use OFETs as switching elements in large-scale flexible matrix displays.

All compounds have continuous conjugated units and are divided into conjugated polymers and conjugated oligomers according to the molecular weight and structure. Oligomers are generally distinguished from polymers in that oligomers usually have a narrow molecular weight distribution and a molecular weight up to about 10 000 g/mol (Da), whereas polymers generally have a correspondingly higher molecular weight and a broader molecular weight distribution. However, it is more sensible to distinguish by the number of repeat units, since a monomer unit can quite possibly reach a molecular weight of 300 to 500 g/mol, as, for example, in the case of (3,3″″-dihexyl) quarterthiophene. In the case of a distinction by the number of repeat units, reference is still made to oligomers in the range of 2 to about 20. However, there is a fluid transition between oligomers and polymers. Often, the difference in the processing of these compounds is also expressed with the distinction between oligomers and polymers. Oligomers are frequently evaporable and can be applied to substrates by means of vapour deposition processes. Irrespective of their molecular structure, polymers frequently refer to compounds which are no longer evaporable and are therefore generally applied by means of other processes.

An important prerequisite for the production of high-value organic semiconductor circuits is compounds of extremely high purity. In semiconductors, order phenomena play an important role. Hindrance of uniform alignment of the compounds and development of particle boundaries lead to a dramatic decline in the semiconductor properties, such that organic semiconductor circuits which have been constructed using compounds not of extremely high purity are generally unusable. Remaining impurities can, for example, inject charges into the semiconductive compound (“doping”) and hence lower the on/off ratio or serve as charge traps and hence drastically lower the mobility. In addition, impurities can initiate the reaction of the semiconductive compounds with oxygen, and oxidizing impurities can oxidize the semiconductive compounds and hence shorten possible storage, processing and operating times.

The most important semiconductive poly- or oligomers include the poly/oligothiophenes whose monomer unit is, for example, 3-hexylthiophene. In the linkage of individual or plural thiophene units to form a polymer or oligomer, it is necessary in principle to distinguish two processes—the single coupling reaction and the multiple coupling reaction in the sense of a polymerization mechanism.

In the single coupling reaction, generally two thiophene derivatives with identical or different structure are coupled with one another in one step, so as to form a molecule which then consists of in each case one unit of the two starting materials. After a removal, purification and another functionalization, this new molecule may in turn serve as a monomer and thus open up access to longer-chain molecules. This process leads generally to exactly one oligomer, the target molecule, and hence to a product with no molar mass distribution and a low level of by-products. It also offers the possibility of building up very defined block copolymers through the use of different starting materials. A disadvantage here is that molecules which consist of more than 2 monomer units can be prepared only in a very complicated manner merely owing to the purification steps and the economic outlay can be justified only for processes with very high quality demands on the product.

One process for synthesizing oligo/polythiophenes is described in EP 1 026 138. In the actual polymerization, a regioselectively prepared Grignard compound is used as the monomer (X=halogen, R=substituent):

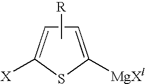

For the polymerization, the polymerization in a catalysis cycle is started by the Kumada method (cross-coupling metathesis reaction) with the aid of a nickel catalyst (preferably Ni(dppp)Cl₂).

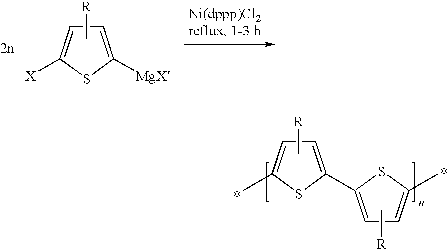

The polymers are generally obtained in the necessary purity via Soxhlet purifications.

In EP 1 026 138, the reaction is likewise effected in such a way that first (as quantitatively as possible) the Grignard reaction is prepared and then the thiophene is polymerized with C—C bond formation by adding the nickel catalyst. In the case of use of metallic magnesium, U.S. Pat. No. 4,521,589 states that a reaction of the dihalogenated thiophene derivative with magnesium in the presence of the nickel catalyst is possible here. Proceeding from the prior art, however, this should be possible only when no organometallic intermediates which themselves constitute a coupling reagent for the Kumada coupling reaction can form. For instance, especially alkylmagnesium halides as used in EP1028136 are suitable as a coupling reagent, as described in WO2006076150. Accordingly, in the reaction with alkylmagnesium halides or with magnesium in the presence of alkyl halides, a broad by-product spectrum would be expected.

It is thus common to the prior art processes that, in the case of use of alkylmagnesium halides or magnesium with catalytic amounts of alkyl bromide, a reactive precursor (for example a Grignard reagent in the Kumada reaction) is always formed only in a first reaction, and then the actual polymerization proceeds in a second reaction, with addition of a catalyst.

However, such a procedure has the disadvantage that it can frequently barely be used, especially in industrial processes, since a continuous reaction is difficult or impossible, and the two-stage process always gives rise to disadvantages that the catalyst is added later and hence possible contaminations or side reactions can arise.

Proceeding from the prior art mentioned, it was therefore an object of the present invention to provide a process which at least partly overcomes the disadvantages mentioned and enables the preparation of polythiophenes or oligothiophenes with defined mean chain lengths and a narrow molecular weight distribution.

This object is achieved by a process according to Claim 1 of the present invention. Accordingly, a process is proposed for polymerizing at least one thiophene derivative having at least two leaving groups, the polymerization proceeding by means of an organometallic thiophene compound and of at least one catalyst, characterized in that a mixture which comprises the at least one thiophene derivative and the at least one catalyst is admixed with at least one metal and/or at least one organometallic compound.

It has been found that, surprisingly, thiophene derivatives can be prepared by means of the process according to the invention in such polymerizations. Troublesome by-products are not observed. As a result, in many applications of the present invention, the possibility is opened up of preparing polythiophenes in a true one-pot synthesis in a technically considerably simplified manner.

In the context of the present invention, the term “thiophene derivative” is understood to mean both mono-, di- or polysubstituted thiophene and unsubstituted thiophene. Preference is given to thiophene derivatives which are alkyl-substituted, particular preference to 3-alkyl-substituted thiophene derivatives.

In the context of the present invention, the term “leaving group” is understood especially to mean any group which is capable of reacting by means of a metal or an organometallic compound to form an organometallic thiophene compound. Particularly preferred leaving groups are halogens, sulphates, sulphonates and diazo groups.

In a preferred embodiment of the invention, the at least one thiophene derivative contains at least two different leaving groups. This can be useful for the achievement of a better regioselectivity of the polymer in many applications of the present invention.

In an alternative preferred embodiment of the invention, the leaving groups of the at least one thiophene derivative are identical.

In the context of the present invention, the term “organometallic thiophene compound” is understood to mean especially a compound in which at least one metal-carbon bond to one of the carbon atoms on the thiophene heterocycle is present.

The term “organometallic compound” is understood to mean especially an organometallic alkyl-metal compound.

Preferred metals within the at least one organometallic thiophene compound are tin, magnesium, zinc and boron. It is pointed out that boron is likewise considered as a metal within the present invention. In the case that the process according to the invention proceeds with the involvement of boron, the leaving group is preferably selected from the group comprising MgBr, MgI, MgCl, Li or mixtures thereof.

The organometallic compounds which are used in the process according to the invention are preferably organometallic tin compounds, for example tributyltin chloride, or zinc compounds, for example activated zinc (Zn*), or borane compounds, for example B(OMe)₃ or B(OH)₃, or magnesium compounds, more preferably organometallic magnesium compounds, more preferably Grignard compounds of the formula R—Mg—X,

where R is alkyl, most preferably C2-alkyl,
and X is halogen, more preferably Cl, Br or I, and especially Br.

In the case that organometallic magnesium compounds are used, the addition is preferably effected by means of metered addition of a solution of this compound, and the solvent need not correspond to that later in the process.

As described, in the process according to the invention, instead of adding at least one organo-metallic compound, it is possible to use at least one metal, preferably selected from the group of zinc, magnesium, tin and boron. In the case that metallic magnesium is used, catalytic amounts of at least one organohalide are added to the reaction mixture. It has been found that, surprisingly and advantageously, the by-products to be expected from the knowledge of the prior art are absent and a polymer is obtained with a very high regioselectivity and narrow molar mass distribution.

The at least one metal can, for example and preferably in this respect, be added in the form of turnings, grains, particles or flakes and subsequently removed, for example, by filtration, or else provided to the reaction chamber in rigid form, for example—but not restricted to—by temporary immersion of wires, grids, meshes or comparable articles into the reaction solution, or else in the form of a cartridge which is equipped with metal in the interior and can be flowed through, or else as a fixed bed in a column in which the metal is present in the form of turnings and is blanketed with solvent, in which case the thiophene derivative(s) is converted as it flows through the cartridge or the column. Corresponding details regarding the continuous conduct of the reaction by means of columns and preferred apparatus are disclosed by patent DE 10304006 B3 or else the publication by Reimschüssel, Journal of Organic Chemistry, 1960, 25, 2256-7, whose embodiments or preferred embodiments for preparing the Grignard reagents also apply to the process according to the invention described here and are hereby incorporated by reference.

Alternatively, the continuous conversion to the Grignard reagent can also be carried out with high turbulence in tubular reactors equipped with static mixers, in which case the liquid column is exposed to pulses, as known from patents DD260276, DD260277 and DD260278, which are hereby incorporated by reference. The embodiments described therein for the preparation of the Grignard reagents are likewise also preferred embodiments for the process according to the invention described here.

In the case of use of elemental magnesium for preparing the organometallic thiophene compound, the reaction preferably proceeds with magnesium provided within the process and in the presence of catalytic amounts of at least one organohalide, preferably alkyl halide, more preferably alkyl bromide, most preferably ethyl bromide. Unconverted magnesium is removed preferably by suitable retaining apparatus, for example metal or glass frits.

The term “catalyst” is understood to mean especially a catalytically active metal compound.

In a preferred embodiment of the invention, the at least one catalyst comprises nickel and/or palladium. This has been found to be favourable in many application examples of the present invention.

More preferably, the at least one catalyst comprises at least one compound selected from the group of nickel and palladium catalysts with ligands selected from the group of tri-tert-butylphosphine, triadamantylphosphine, 1,3-bis(2,4,6-trimethylphenyl)imidazolidinium chloride, 1,3-bis(2,6-diisopropylphenyl) imidazolidinium chloride or 1,3-diadamantylimidazolidinium chloride or mixtures thereof; bis(triphenylphosphino)palladium dichloride (Pd(PPh₃)Cl₂), palladium(II) acetate (Pd(OAc)₂), tetrakis(triphenylphosphine)palladium (Pd(PPh₃)₄), tetrakis(triphenylphosphine)nickel (Ni(PPh₃)₄), nickel(II) acetylacetonate Ni(acac)₂, dichloro(2,2′-bipyridine)nickel, dibromobis(triphenylphosphine)nickel (Ni(PPh₃)₂Br₂), bis(diphenylphosphino)propanenickel dichloride (Ni(dppp)Cl₂) or bis(diphenylphosphino)ethanenickel dichloride Ni(dppe)Cl₂ or mixtures thereof.

The amount of the catalyst added often depends on the target molecular weight and is typically within the range of ≧0.1-≦20 mol %, preferably in the range of ≧1-≦17.5 mol %, more preferably in the range of ≧2-≦15 mol %, based in each case on the molar amount of the thiophene derivative used.

General group definitions: Within the description and the claims, general groups, for example: alkyl, alkoxy, aryl, etc., are claimed and described. Unless stated otherwise, the following groups within the groups described in general are used with preference in the context of the present invention:

alkyl: linear and branched C1-C8-alkyls,
long-chain alkyls: linear and branched C5-C20 alkyls,
alkenyl: C2-C8-alkenyl,
cycloalkyl: C3-C8-cycloalkyl,
alkoxy: C1-C6-alkoxy,
long-chain alkoxy: linear and branched C5-C5 alkoxy,
alkylene: selected from the group comprising:
methylene; 1,1-ethylene; 1,2-ethylene; 1,1-propylidene; 1,2-propylene; 1,3-propylene; 2,2-propylidene; butan-2-ol-1,4-diyl; propan-2-ol-1,3-diyl, 4-butylene; cyclohexane-1,1-diyl; cyclohexane-1,2-diyl; cyclohexane-1,3-diyl; cyclohexane-1,4-diyl; cyclopentane-1,1-diyl; cyclopentane-1,2-diyl; and cyclopentane-1,3-diyl,
aryl: selected from aromatics having a molecular weight below 300 Da,
arylene: selected from the group comprising: 1,2-phenylene; 1,3-phenylene; 1,4-phenylene; 1,2-naphthalenylene; 1,3-naphthalenylene; 1,4-naphthalenylene; 2,3-naphthalenylene; 1-hydroxy-2,3-phenylene; 1-hydroxy-2,4-phenylene; 1-hydroxy-2,5-phenylene; and 1-hydroxy-2,6-phenylene,
heteroaryl: selected from the group comprising: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; thiophenyl; carbazolyl; indolyl; and isoindolyl, where the heteroaryl may be bonded to the compound via any atom in the ring of the selected heteroaryl,
heteroarylenes: selected from the group comprising: pyridinediyl; quinolinediyl; pyrazodiyl; pyrazolediyl; triazolediyl; pyrazinediyl, thiophenediyl; and imidazolediyl, where the heteroarylene functions as a bridge in the compound via any atom in the ring of the selected heteroaryl; especially preferred are: pyridine-2,3-diyl; pyridine-2,4-diyl; pyridine-2,5-diyl; pyridine-2,6-diyl; pyridine-3,4-diyl; pyridine-3,5-diyl; quinoline-2,3-diyl; quinoline-2,4-diyl; quinoline-2,8-diyl; isoquinoline-1,3-diyl; isoquinoline-1,4-diyl; pyrazole-1,3-diyl; pyrazole-3,5-diyl; triazole-3,5-diyl; triazole-1,3-diyl; pyrazine-2,5-diyl; and imidazole-2,4-diyl, thiophene-2,5-diyl, thiophene-3,5-diyl; a C1-C6-heterocycloalkyl, selected from the group comprising: piperidinyl; piperidine; 1,4-piperazine, tetrahydrothiophene; tetrahydrofuran; 1,4,7-triazacyclononane; 1,4,8,11-tetraazacyclotetradecane; 1,4,7,10,13-pentaazacyclopentadecane; 1,4-diaza-7-thiacyclononane; 1,4-diaza-7-oxa-cyclononane; 1,4,7,10-tetraazacyclododecane; 1,4-dioxane; 1,4,7-trithiacyclononane; pyrrolidine; and tetrahydropyran, where the heteroaryl may be bonded to the C1-C6-alkyl via any atom in the ring of the selected heteroaryl,
heterocycloalkylenes: selected from the group comprising: piperidin-1,2-ylene; piperidin-2,6-ylene; piperidin-4,4-ylidene; 1,4-piperazin-1,4-ylene; 1,4-piperazin-2,3-ylene; 1,4-piperazin-2,5-ylene; 1,4-piperazin-2,6-ylene; 1,4-piperazin-1,2-ylene; 1,4-piperazin-1,3-ylene; 1,4-piperazin-1,4-ylene; tetrahydrothiophen-2,5-ylene; tetrahydrothiophen-3,4-ylene; tetrahydrothiophen-2,3-ylene; tetrahydrofuran-2,5-ylene; tetrahydrofuran-3,4-ylene; tetrahydrofuran-2,3-ylene; pyrrolidin-2,5-ylene; pyrrolidin-3,4-ylene; pyrrolidin-2,3-ylene; pyrrolidin-1,2-ylene; pyrrolidin-1,3-ylene; pyrrolidin-2,2-ylidene; 1,4,7-triazacyclonon-1,4-ylene; 1,4,7-triazacyclonon-2,3-ylene; 1,4,7-triazacyclonon-2,9-ylene; 1,4,7-triazacyclonon-3,8-ylene; 1,4,7-triazacyclonon-2,2-ylidene; 1,4,8,11-tetraazacyclotetradec-1,4-ylene; 1,4,8,11-tetraazacyclotetradec-1,8-ylene; 1,4,8,11-tetra-azacyclotetradec-2,3-ylene; 1,4,8,11-tetraazacyclotetradec-2,5-ylene; 1,4,8,11-tetraazacyclo-tetradec-1,2-ylene; 1,4,8,11-tetraazacyclotetradec-2,2-ylidene; 1,4,7,10-tetraazacyclododec-1,4-ylene; 1,4,7,10-tetraazacyclododec-1,7-ylene; 1,4,7,10-tetraazacyclododec-1,2-ylene; 1,4,7,10-tetraazacyclododec-2,3-ylene; 1,4,7,10-tetraazacyclododec-2,2-ylidene; 1,4,7,10,13-pentaazacyclo-pentadec-1,4-ylene; 1,4,7,10,13-pentaazacyclopentadec-1,7-ylene; 1,4,7,10,13-pentaazacyclopenta-dec-2,3-ylene; 1,4,7,10,13-pentaazacyclopentadec-1,2-ylene; 1,4,7,10,13-pentaazacyclopentadec-2,2-ylidene; 1,4-diaza-7-thia-cyclonon-1,4-ylene; 1,4-diaza-7-thia-cyclonon-1,2-ylene; 1,4-diaza-7-thia-cyclonon-2,3-ylene; 1,4-diaza-7-thia-cyclonon-6,8-ylene; 1,4-diaza-7-thia-cyclonon-2,2-ylidene; 1,4-diaza-7-oxacyclonon-1,4-ylene; 1,4-diaza-7-oxa-cyclonon-1,2-ylene; 1,4-diaza-7-oxa-cyclonon-2,3-ylene; 1,4-diaza-7-oxa-cyclonon-6,8-ylene; 1,4-diaza-7-oxa-cyclonon-2,2-ylidene; 1,4-dioxan-2,3-ylene; 1,4-dioxan-2,6-ylene; 1,4-dioxan-2,2-ylidene; tetrahydropyran-2,3-ylene; tetrahydropyran-2,6-ylene; tetrahydropyran-2,5-ylene; tetrahydropyran-2,2-ylidene; 1,4,7-trithia-cyclonon-2,3-ylene; 1,4,7-trithiacyclonon-2,9-ylene; and 1,4,7-trithiacyclonon-2,2-ylidene,
heterocycloalkyl: selected from the group comprising: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thiacyclononanyl; 1,4-diaza-7-oxa-cyclononanyl; 1,4,7,10-tetraazacyclododecanyl; 1,4-dioxanyl; 1,4,7-trithiacyclononanyl; tetrahydropyranyl; and oxazolidinyl, where the heterocycloalkyl may be bonded to the compound via any atom in the ring of the selected heterocycloalkyl,
halogen: selected from the group comprising: F; Cl; Br and I,
haloalkyl: selected from the group comprising mono-, di-, tri-, poly- and perhalogenated linear and branched C1-C8-alkyl,
pseudohalogen: selected from the group comprising —CN, —SCN, —OCN, N3, —CNO, —SeCN.

Unless stated otherwise, the following groups are more preferred groups within the general group definitions:

alkyl: linear and branched C1-C6-alkyl,
long-chain alkyls: linear and branched C5-C10 alkyl, preferably C6-C8 alkyls,
alkenyl: C3-C6-alkenyl,
cycloalkyl: C6-C8-cycloalkyl,
alkoxy: C1-C4-alkoxy,
long-chain alkoxy: linear and branched C5-C10 alkoxy, preferably linear C6-C8 alkoxy,
alkylene: selected from the group comprising: methylene; 1,2-ethylene; 1,3-propylene; butan-2-ol-1,4-diyl; 1,4-butylene; cyclohexane-1,1-diyl; cyclohexane-1,2-diyl; cyclohexane-1,4-diyl; cyclopentane-1,1-diyl; and cyclopentane-1,2-diyl,
aryl: selected from the group comprising: phenyl; biphenyl; naphthalenyl; anthracenyl; and phenanthrenyl,
arylene: selected from the group comprising: 1,2-phenylene; 1,3-phenylene; 1,4-phenylene; 1,2-naphthalenylene; 1,4-naphthalenylene; 2,3-naphthalenylene and 1-hydroxy-2,6-phenylene,
heteroarylene: thiophene, pyrrole, pyridine, pyridazine, pyrimidine, indole, thienothiophene,
halogen: selected from the group comprising: Br and Cl, more preferably Br.

In a preferred embodiment of the invention, the at least one thiophene derivative comprises at least one compound of the general formula:

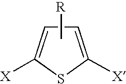

where R is selected from the group comprising hydrogen, hydroxyl, halogen, pseudohalogen, formyl, carboxyl and/or carbonyl derivatives, alkyl, long-chain alkyl, alkoxy, long-chain alkoxy, cycloalkyl, haloalkyl, aryl, arylene, haloaryl, heteroaryl, heteroarylene, heterocycloalkylene, heterocycloalkyl, haloheteroaryl, alkenyl, haloalkenyl, alkynyl, haloalkynyl, keto, ketoaryl, haloketoaryl, ketoheteroaryl, ketoalkyl, haloketoalkyl, ketoalkenyl, haloketoalkenyl, phosphoalkyl, phosphonates, phosphates, phosphine, phosphine oxide, phosphoryl, phosphoaryl, sulphonyl, sulphoalkyl, sulphoarenyl, sulphonate, sulphate, sulphone, amine, polyether, silylalkyl, silylalkyloxy, where, in the case of suitable radicals, one or more nonadjacent CH₂ groups may independently be replaced by —O—, —S—, —NH—, —NR—, —SiRR—, —CO—, —COO—, —OCO—, —OCO—O—, —SO₂—, —S—CO—, —CO—S—, —CY¹═CY² or —C≡C—, and in such a way that oxygen and/or sulphur atoms are not bonded directly to one another (terminal CH₃ groups are interpreted as CH₂ groups in the sense of CH₂—H)
and where X and X′ are each independently a leaving group, preferably halogen, more preferably Cl, Br or I and especially preferably Br.

In a preferred embodiment of the invention, the mixture of the thiophene derivative and of the at least one catalyst and/or of the metal or of the organometallic compound comprises a solvent.

Suitable solvents are, for example, aliphatic hydrocarbons, for example alkanes, especially pentane, hexane, cyclohexane or heptane, unsubstituted or substituted aromatic hydrocarbons, for example benzene, toluene and xylenes, and compounds containing ether groups, for example diethyl ether, tert-butyl methyl ether, dibutyl ether, amyl ethers, dioxane and tetrahydrofuran (THF), and solvent mixtures of the aforementioned groups, for example a mixture of THF and toluene. In the process according to the invention, preference is given to using solvents which contain ether groups. Very particular preference is given to tetrahydrofuran. However, it is also possible and preferred for numerous working examples of the present invention to use mixtures of two or more of these solvents as the solvent. For example, it is possible to use mixtures of the tetrahydrofuran solvent used with preference and alkanes, for example hexane (for example present in commercially available solutions of starting materials such as organometallic compounds). What is important in the context of the invention is that the solvent, the solvents or the mixtures thereof are selected such that, prior to addition of the catalyst, the thiophene derivatives used or the polymerization-active monomers are present in dissolved form. Also suitable for the workup are halogenated aliphatic hydrocarbons such as methylene chloride and chloroform.

In a preferred embodiment of the process according to the invention, the reaction is ended (“quenched”) by adding a hydrolyzing solvent to the polymerization solution, preferably an alkyl alcohol, more preferably ethanol or methanol, most preferably methanol.

The workup is effected preferably by filtering off the precipitated product, washing it with the precipitant and then taking it up in a solvent.

Alternatively and likewise preferably, a purification can be effected in a Soxhlet, in which case preference is given to using nonpolar solvents, for example hexane, as the extractant.

In a preferred embodiment of the invention, the process is used to prepare copolymers and/or block polymers.

For the preparation of copolymers and/or block polymers, but also for larger homogeneous polymers, in a preferred embodiment of the invention, first the mixture of the thiophene derivative and of the at least one catalyst and/or of the metal or of the organometallic compound is reacted, then at least one further solution consisting of polymerization-active thiophene monomer and/or two solutions consisting of a) at least one thiophene monomer with two leaving groups and b) a metal or an organometallic compound are metered in with the purpose of chain extension on the basis of the same thiophene derivative and/or of at least one other thiophene derivative to prepare block copolymers or copolymers.

In a preferred embodiment of the invention, the process is carried out batchwise.

In a preferred embodiment of the invention, the process is carried out continuously.

In a preferred embodiment of the process according to the invention for continuously preparing the polythiophenes, the polymerization-active monomer is polymerized in situ by mixing an organometallic reagent with the at least one thiophene derivative with two leaving groups or by reacting the thiophene derivative with two leaving groups with metal on a column, as described in DE 10304006 B3 or by Reimschüssel, Journal of Organic Chemistry, 1960, 25, 2256-7, in a corresponding cartridge or in a tubular reactor provided with static mixers, as described in DD260276, DD260277 and DD260278, in the presence of the polymerization-active catalyst in a first module.

In a second module, at least one further—identical or at least one different—monomer is metered in. Preference is given to conveying two metered streams, in each case one for the solution consisting of the thiophene derivative with two leaving groups and one solution consisting of the organometallic compound. The reactant streams are mixed rapidly by a mixer. After mixing and polymerization in one module, preferably, in a further module, further—identical or at least one different—monomer is correspondingly metered in at least once and polymerized.

In many embodiments of the present invention, the continuous reaction is particularly advantageous, since it often enables higher space-time yields compared to the batchwise reaction of the prior art and leads to defined poly- and oligothiophenes with a narrow molecular weight distribution. Thus, inexpensive well-defined poly- and oligothiophenes are often obtainable in a surprisingly simple manner.

The process according to the invention serves to prepare poly- and oligothiophenes. Preference is given to the preparation of degrees of polymerization or numbers of repeat units n in the chain of ≧2 to ≦5000, especially of ≧5 to ≦2500, more preferably of ≧100 to ≦1000.

Depending on the molecular weight of the monomeric thiophene derivative, the molecular weight is ≧1000 to ≦300 000, preferably ≧2000 to ≦100 000, more preferably ≧5000 to ≦80 000, especially preferably ≧10 000 to ≦60 000.

In the case of oligothiophenes, preference is given to the preparation of chain lengths with n≧2 to ≦20 monomer units, preferably of ≧3 to ≦10, more preferably of ≧4 to ≦8.

Also preferred is a narrow molecular weight distribution with a polydispersity index PDI of ≧1 to 5≦3, preferably PDI≦2, more preferably PDI≧1.1 to ≦1.7.

The present process is notable especially in that, in many applications, the mean molecular weight or the mean chain length can be adjusted in a technically considerably simpler and accurately defined manner through the amount of catalyst by virtue of the one-stage reaction of thiophene derivative, catalyst and alkylmagnesium bromide.

Furthermore, the present process is notable, in many applications, in that the continuous conduct of the reaction leads to higher space-time yields than comparable batchwise polymerizations of the prior art.

The fact that complicated purifications of any intermediates are not necessary considerably increases the economic attractiveness of the process and also facilitates the industrial performance.

The polymers and oligomers prepared by the process are additionally notable, in many embodiments, for the presence of one or two leaving groups at the chain end, which can serve later as substitution sites for functionalizations or end-capping reactions.

For a preferred embodiment of the present invention, after performing the polymerization but before the workup (especially the quenching), reaction is effected with a thiophene derivative having only one leaving group. This can achieve a so-called end-capping. The thiophene derivative having only one leaving group preferably possesses a radical which can be functionalized further, preferably in the 5 position, which is preferably selected from the group of phosphoalkyl, phosphonate, phosphate, phosphine, phosphine oxide, phosphoryl, phosphoaryl, sulphonyl, sulphoalkyl, sulphoarenyl, sulphonate, sulphate, sulphone or mixtures thereof. This has been found to be advantageous for many applications of the present invention.

Temperatures suitable for the performance of the process according to the invention are generally in the range of ≧+20 to ≦+200° C., preferably in the range of ≧+80 to ≦+160° C. and especially ≧+100 to ≦+140° C. Owing to the low boiling points of the solvents used, the reaction is effected at elevated pressures, preferably at ≧1-≦30 bar, especially at ≧2-≦15 bar and more preferably in the range of ≧4-≦10 bar.

The rates of metered addition depend primarily on the desired residence times or conversions to be achieved.

Typical residence times are in the range of ≧5 min to ≦120 min. The residence time is preferably between ≧10 and ≦40 min, preferentially in the range of ≧20-≦40 min.

Particularly advantageous and preferred in this regard within the present invention is the use of microreaction technology.

By virtue of the use of a micromixer (μ-mixer), the reaction solutions are mixed with one another very rapidly, which prevents broadening of the molecular weight distribution owing to possible radial concentration gradients. In addition, microreaction technology (μ-reaction technology) in a microreactor (μ-reactor) enables a usually significantly narrower residence time distribution than in conventional continuous apparatus, which likewise prevents broadening of the molecular weight distribution.

In a particularly preferred embodiment, the process according to the invention is carried out continuously using μ-reaction technology apparatus.

After the reaction of the mixture of the catalyst and of the thiophene derivative with the organometallic compound or the metal, preference is given to another metered addition of an organometallic thiophene derivative prepared in situ or in advance with the aid of a μ-mixer and the conversion to the desired product in a suitable, temperature-controlled delay zone.

The process according to the invention is notable, in particular, in many applications, for the possibility of controlled establishment of a desired mean chain length, and also for the preparation of products with a narrow molecular weight distribution. In addition, continuous conduct of the polymerization in many applications enables a significant increase in the space-time yield.

The inventive use of a two-stage metered addition strategy for the polymerization of the organometallic thiophene derivative allows, in many applications, with regard to the desired mean chain length or molecular weights, a very significant reduction in the amounts of the catalyst needed or a significant lowering of the mean molecular weights for a given amount of catalyst.

The invention likewise provides the oligothiophenes obtained by the process according to the invention.

The aforementioned components to be used in accordance with the invention, and also those claimed and those described in the working examples, are not subject, in terms of their size, shape configuration, material selection and technical design, to any particular exceptional conditions, such that the selection criterion known in the field of use can be applied without restriction.

Further details, features and advantages of the subject-matter of the invention are evident from the subclaims and from the description of the accompanying drawings which follows, in which—by way of example—a working example of the process according to the invention is shown. The drawings show:

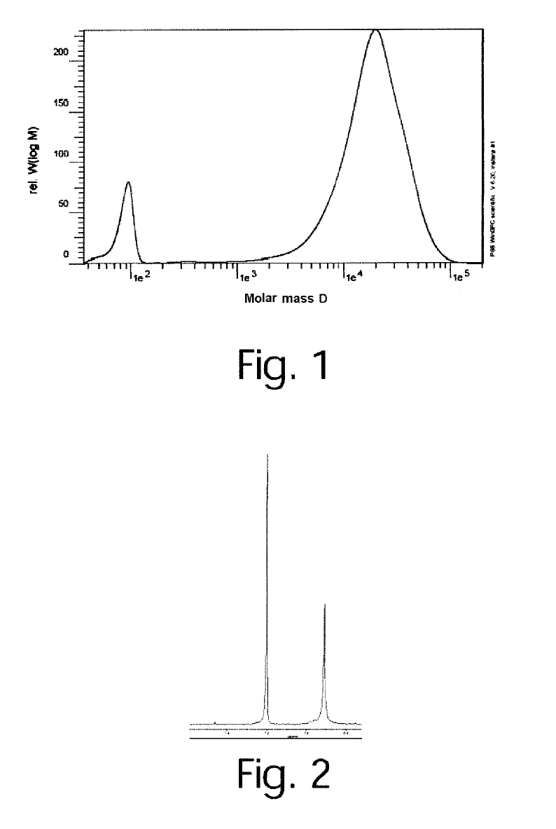

FIG. 1 the molar mass distribution of a polythiophene according to Example 1 of the present invention

FIG. 2 a section of an NMR spectrum of the polythiophene according to Example 1 of the present invention, in the range of δ=7.4 to δ=6.8; and

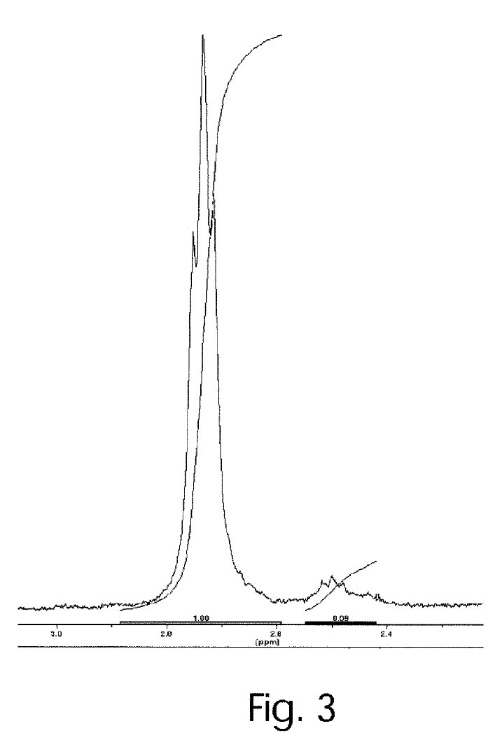

FIG. 3 a section of an NMR spectrum of the polythiophene according to Example 1 of the present invention, in the range of δ=3.0 to δ=2.4.

FIGS. 1 to 3 relate to a polythiophene which has been prepared according to Example 1 of the present invention.

Example 1 should be understood purely illustratively and does not constitute any restriction of the present invention, which is defined purely by the claims.

### EXAMPLE 1

### Preparation of poly-3-hexylthiophene

### Reactants:

| | | |
|---|---|---|
| 2,5-Dibromo-3-hexylthiophene | 4.92 | g (15 mmol) |
| EtMgBr solution in hexane | 15.1 | ml (15.1 mmol) |
| Ni(dppp)Cl₂: | 86 | mg (0.16 mmol) |
| THF | 90 | ml |

### Reaction Equation:

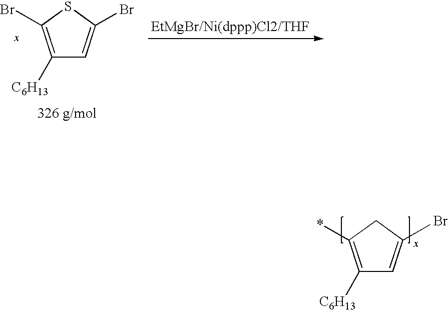

### Experimental Setup:

Small 3-Neck Flask, Reflux Condenser, Schlenk Technology

Reaction temperature 50° C., duration: 4 h

Under inert gas conditions, the reaction flask was initially charged with 2,5-dibromo-3-hexyl-thiophene, 90 ml of THF and nickel catalyst, and then the EtMgBr in hexane using Schlenk technology was added. The mixture is stirred at 50° C. for about 4 h.

To end the reaction, for quenching, about 5-10 times the volume of methanol was added. The precipitated solid was left to stand overnight and filtered off.

The solid obtained was purified with hexane with the aid of a Soxhlet extraction (oligomer removal) and then taken up in methylene chloride. 1.8 g of solid were obtained (72% yield).

FIG. 1 shows the molar mass distribution after the Soxhlet extraction in a GPC spectrum. A narrow molar mass distribution is clearly discernible with the peak at about 18 500 Da (measured against polystyrene standards, THF as the eluent).

FIG. 2 and FIG. 3 show sections of the ¹H NMR spectrum of the reaction product, once in the range of δ=7.4 to δ=6.8 (i.e. in the region of the 4-H ring proton of the thiophene), once in the range of δ=3.0 to δ=2.4 (i.e. in the region of the CH₂ group adjoining the thiophene) (recorded in CDCl₃ at 400 MHz with TMS as the internal standard).

As can be seen clearly from FIG. 2 and especially from FIG. 3, a high regioselectivity has been achieved, which is >90%.

1. Process for polymerizing at least one thiophene derivative having at least two leaving groups, the polymerization proceeding by means of an organometallic thiophene compound and of at least one catalyst, wherein a mixture which comprises the at least one thiophene derivative and the at least one catalyst is admixed with at least one metal and/or at least one organometallic compound.

2. Process according to claim 1, wherein the at least one thiophene derivative contains at least one leaving group selected from the group consisting of halogens, sulphates, sulphonates and diazo groups.

3. Process according to claim 1 or 2, characterized in that, wherein the leaving groups of the at least one thiophene derivative are identical.

4. Process according to claim 1, wherein the organometallic thiophene compound contains at least one metal selected from the group consisting of zinc, magnesium, tin and boron.

5. Process according to claim 1, wherein the mixture which comprises the at least one thiophene derivative and the at least one catalyst is admixed with at least one metal selected from the group consisting of zinc, magnesium, tin and boron.

6. Process according to claim 4, wherein the at least one metal is magnesium in the presence of at least one organohalide.

7. Process according to claim 1, wherein the at least one catalyst comprises nickel and/or palladium.

8. Process according to claim 1, wherein the at least one thiophene derivative comprises at least one compound of the formula: 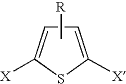
where R is selected from the group consisting of hydrogen, hydroxyl, halogen, pseudohalogen, formyl, carboxyl and/or carbonyl derivatives, alkyl, long-chain alkyl, alkoxy, long-chain alkoxy, cycloalkyl, haloalkyl, aryl, arylene, haloaryl, heteroaryl, heteroarylene, heterocycloalkylene, heterocycloalkyl, haloheteroaryl, alkenyl, haloalkenyl, alkynyl, haloalkynyl, keto, ketoaryl, haloketoaryl, ketoheteroaryl, ketoalkyl, haloketoalkyl, ketoalkenyl, haloketoalkenyl, phosphoalkyl, phosphonates, phosphates, phosphine, phosphine oxide, phosphoryl, phosphoaryl, sulphonyl, sulphoalkyl, sulphoarenyl, sulphonate, sulphate, sulphone, amine, polyether, silylalkyl and silylalkyloxy, where, in the case of suitable radicals, one or more nonadjacent CH₂ groups optionally are independently replaced by —O—, —S—, —NH—, —NR—, —SiRR—, —CO—, —COO—, —OCO—, —OCO—O—, —SO₂—, —S—CO—, —CO—S—, —CY¹═CY² or —C≡C—, and in such a way that oxygen and/or sulphur atoms are not bonded directly to one another (terminal CH₃ groups are interpreted as CH₂ groups in the sense of CH₂—H)
and where X and X′ are each independently Cl, Br or I.

9. Process according to claim 1, wherein the at least one catalyst comprises at least one compound selected from the group consisting of nickel and palladium catalysts with ligands selected from the group consisting of tri-tert-butylphosphine, triadamantylphosphine, 1,3-bis(2,4,6-trimethylphenyl)imidazolidinium chloride, 1,3-bis(2,6-diisopropylphenyl)imidazolidinium chloride or 1,3-diadamantylimidazolidinium chloride or mixtures thereof; bis(triphenylphosphino)palladium dichloride (Pd(PPh₃)Cl₂), palladium(II) acetate (Pd(OAc)₂), tetrakis(triphenylphosphine)palladium (Pd(PPh₃)₄), tetrakis(triphenylphosphine)nickel (Ni(PPh₃)₄), nickel(II) acetylacetonate Ni(acac)₂, dichloro(2,2′-bipyridine)nickel, dibromobis(triphenylphosphine)nickel (Ni(PPh₃) Br₂), bis(diphenylphosphino)propanenickel dichloride (Ni(dppp)Cl₂), bis(diphenylphosphino)ethanenickel dichloride Ni(dppe)Cl₂ and mixtures thereof.

10. Process according to claim 1, wherein said process is performed batchwise.

11. Process according to claim 1, wherein said process is performed continuously.

12. Process according to claim 1, wherein said process is performed at a temperature of ≧+20 to ≦+200° C.

13. Process according to any claim 1, wherein said process is performed at a pressure of ≧1-≦30 bar.

14. Poly/oligothiophene prepared by the process of claim 1.

15. Oligothiophene according to claim 13 with a chain length of n≧2 to ≦20 monomer units.

16. Oligothiophene according to claim 14 or 15 having a polydispersity index PDI of ≧1 to ≦3.

17. Polythiophene according to claim 14 having a molecular weight of ≧1000 to ≦30 000.
